(19) United States
(12) Patent Application Publication
(10) Pub. No.: US 2004/0130843 A1
(43) Pub. Date: Jul. 8, 2004

(54) EMI suppressing cable and method of producing EMI suppressing cable

(76) Inventors: Takaki Tsutsui, Tokyo (JP); Tomonori Nakata, Tokyo (JP)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/739,141

(22) Filed: Dec. 19, 2003

(30) Foreign Application Priority Data
Dec. 24, 2002 (JP) P.2002-372782
Dec. 24, 2002 (JP) P.2002-372787

(51) Int. Cl. H02H 9/06

(52) U.S. Cl. 361/118

(57) ABSTRACT

An EMI suppressing cable includes a core wire bundle including a plurality of core wires which are respectively covered with insulative covering layers, a ferrite compound-mixed resin layer covering the core wire bundle, and a sheath layer covering the ferrite compound-mixed resin layer.

Also, a method of producing an EMI suppressing cable, including the steps of: providing a core wire bundle which includes a plurality of core wires respectively covered with insulative covering layers; covering the core wire bundle with a shielding layer; covering the shielding layer with a ferrite compound-mixed resin layer; and covering the ferrite compound-mixed resin layer with a sheath layer.

### BACKGROUND OF THE INVENTION

The present invention relates to an EMI (electromagnetic interference) suppressing cable and a method of producing the EMI suppressing cable, and in particular to an EMI suppressing cable which can efficiently suppress EMI noises by a ferrite compound-mixed resin layer, and is produced at low production cost, and method of producing the EMI suppressing cable.

Recently, for suppressing interference of electromagnetic waves (EMI), as shown in FIG. 5, a ferrite core 2 mounted on the way of a cable 1 is known. Also, a ferrite core 2 is mounted near a connector 3, and in addition ferrite cores are in general plural for increasing the EMI suppressing effect. External EMI noises are suppressed from invasion by covering an outside part of the cable 1. At the same time, radiation of EMI noise from a signal conductor toward an outside is suppressed. Further, the related art has equipped interior electronic parts, for example, ferrite bead chips or coils as countermeasures to EMI noise, or provided such as shields at a portion of an electronic circuit for enhancing the countermeasure to EMI noise.

However, the outside mounting of the ferrite core 2 has been not only troublesome but also restrained because of increasing the mounting spaces and weight, and caused cost-up similarly to addition of the internal electronic parts or shielding on the portion of the electronic circuit.

Therefore, for dissolving such inconveniences, as shown in FIG. 6, JP-A-6-203652 discloses a shielded cable 8 in which a first insulating layer around core wires 4, a shielding layer 6 and a second insulating layer 7 are alternately laminated. Also, an amorphous magnetic tape 9 is wound on at least one part of an outer circumference of the second insulating layer 7. (For example, JP-A-6-203652, page 1 to 4, FIGS. 1 and 2)

The cable disclosed in JP-A-6-203652 has advantageous with respect to restrictions such as the mounting space and weight in comparison with the related cable having the ferrite core. However, the suppressing effect of EMI noise is very low since a base tape of the amorphous magnetic tape composing the amorphous magnetic substance is made of polyester or PPS (polyphenylene sulfide). Also, the amorphous magnetic tape is also wound around only one portion of the second insulating layer.

### SUMMARY OF THE INVENTION

It is therefore an object of the present invention to provide an EMI suppressing cable capable of properly maintaining the suppressing effect of EMI noise and decreasing in cost.

In order to achieve the above object, according to the present invention, there is provided an EMI suppressing cable, comprising:

a core wire bundle, including a plurality of core wires which are respectively covered with insulative covering layers;

a ferrite compound-mixed resin layer, covering the core wire bundle; and

a sheath layer, covering the ferrite compound-mixed resin layer.

Preferably, a shielding layer is interposed between the core wire bundle and the ferrite compound-mixed resin layer.

Preferably, the ferrite compound-mixed resin layers are formed by an extrusion formation.

In the above configurations, when the resin solution mixed with the ferrite compound is extrusion-formed as the core of the core wire bundle, the ferrite compound-mixed resin is formed very easily and smoothly over the full length of the cable, and at the same time, the EMI suppressing effect can be efficiently displayed over the full length of the cable.

The ferrite compound can be mixed evenly and thoroughly in the resin, and by properly numerically adjusting the containing amount or thickness of the ferrite compound, it is possible to offer the effective EMI suppressing cable at lower cost than that of the related art, and the noise shielding effect is large together with the shielding layer. The ferrite compound-mixed resin layer of the invention has the larger permeability and the more preferable frequency characteristics than those of the layers of conventional magnetic substance. Accordingly, the EMI suppressing cable of the invention exhibit the considerably high EMI suppressing effect, and at the same time is also advantageous in the restriction of the furnishing space and weight in comparison with the outside furnishing type of the related art. In addition, since the whole is flexible, the connection to the electronic machinery is easy. Thus, the invention displays the considerable effects.

Here, it is preferable that, the shielding layer is comprised of a flexibility conductive material having at least one of a metal-braided wire layer, a metal tape layer and a metal foil.

Here, it is preferable that, the ferrite compound-mixed resin layer is a ferrite compound-mixed resin tape in which ferrite powders are evenly compound within resin. The ferrite compound-mixed resin tape covers the shielding layer.

Here, it is preferable that, the ferrite compound-mixed resin tape is spirally wound on the shielding layer around an axis direction of the core wire bundle.

Here, it is preferable that, the ferrite compound-mixed resin tape is wound on the shielding layer in a direction perpendicular to an axis direction of the core wire bundle.

According to the present invention, there is also provided a method of producing an EMI suppressing cable, comprising the steps of:

providing a core wire bundle which includes a plurality of core wires respectively covered with insulative covering layers;

covering the core wire bundle with a shielding layer;

covering the shielding layer with a ferrite compound-mixed resin layer; and

covering the ferrite compound-mixed resin layer with a sheath layer.

In the above method, the form of the layered structure is employed and the production process is simplified, thereby increasing the productivity. Further since the shielding layer and the ferrite compound-mixed resin layer has the excellent EMI noise suppressing function, the reliability and the durability of the EMI suppressing cable are improved. The related outside mounted ferrite core and the controlling parts are no longer necessary to contribute to the cost-down in company with the simple production procedure.

Preferably, the ferrite compound-mixed resin layers are formed by an extrusion formation.

Preferably, the shielding layer is comprised of a flexibility conductive material having at least one of a metal-braided wire layer, a metal tape layer and a metal foil.

In the methods, the core wire bundle is protected by the shielding layer from injuries, and the ferrite compound-mixed sheath layer is also supported to heighten the EMI noise suppressing function, the reliability and the durability by the excellent EMI noise suppressing function of the ferrite compound-mixed resin layer together with the shielding layer.

Preferably, the ferrite compound-mixed resin layer is a ferrite compound-mixed resin tape, and the method further comprising the step of covering the shielding layer with the ferrite compound-mixed resin tape formed by adjusting a mixing ratio of ferrite powders in the resin so that the ferrite powders is evenly compound in the resin.

Here, it is preferable that, the ferrite compound-mixed resin tape is spirally wound on the shielding layer around an axis direction of the core wire bundle while adjusting a winding pitch.

Here, it is preferable that, the ferrite compound-mixed resin tape is wound on the shielding layer in a direction perpendicular to an axis direction of the core wire bundle.

In the methods, it is possible to easily form the ferrite compound-mixed resin layer, and accordingly offer the more effective EMI suppressing cable cheaper than that of the prior art. Further, the EMI suppressing cable is enabled to be thin layer and reduced in size, displaying the similar effect to that of the invention of the first or second aspects. In addition, spirally winds the ferrite compound-mixed resin tape of narrow width on the shielding layer by adjusting the winding pitch, so that the above mentioned effect is more heightened.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 shows a perspective view of the EMI suppressing cable, according to a first embodiment of the invention;

FIG. 2 shows a cross sectional view of the core wire of FIG. 1;

FIG. 3 shows a perspective view of the EMI suppressing cable according to a second embodiment of the invention;

FIG. 4 shows a perspective view of the EMI suppressing cable according to a third embodiment of the invention;

FIG. 5 shows a side view of the related EMI suppressing cable; and

FIG. 6 shows a side view of another related EMI suppressing cable.

### DETAILED DESCRIPTION OF THE PREFERRED EMBODIMENTS

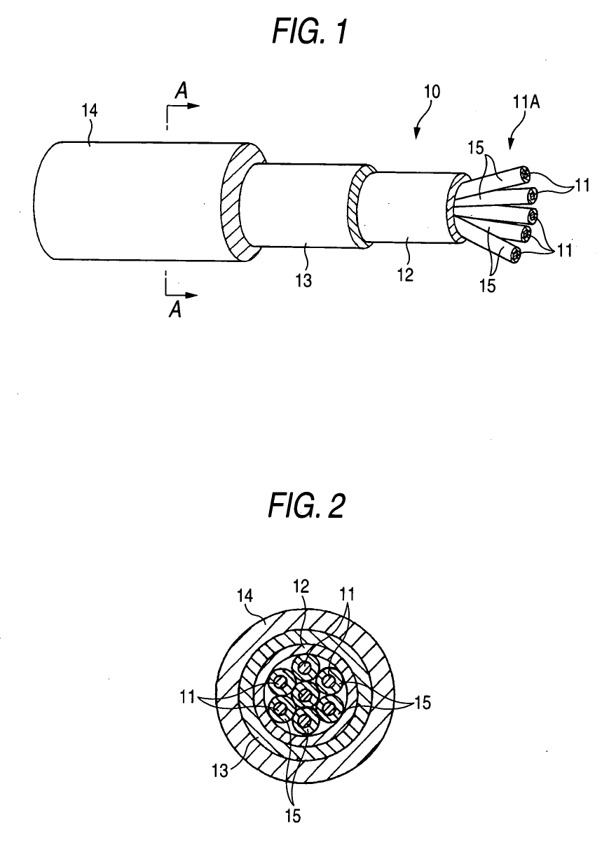

In the following description, a first embodiment of the invention will be explained in detail, referring to FIGS. 1 and 2. FIGS. 1 and 2 show an EMI suppressing cable 10. The EMI suppressing cable 10 includes a core wire bundle 11A, a shielding layer 12 shielded on the core wire bundle 11A, a ferrite compound-mixed resin layer 13 shielded on the shielding layer 12, and an outer shielding layer 14 called as a sheath layer shielded on the ferrite compound-mixed resin layer 13.

By the way, a plurality of core wires 11 are twisted in the core wire bundle 11A. For example, the core wire 11 corresponds to a signal conductor for a home game controller, and is composed of a metal wire of copper or gold excellent in conductivity, and the core wires 11 are respectively covered with flexible insulating materials 15 to avoid short circuit in relation with adjoining core wires 11 but no limitation should be made thereto.

The shielding layer 12 shielding the core wire bundle 11A is composed of metal-braided wires conventionally used in general, but no limitation should be made thereto, and being a conductive material of flexibility, for example, arbitrary materials as a metal foil or a metal tape may be selected. Thus, the shielding layer 12 composed of the conductive material may exhibit shielding effect of the EMI suppressing cable 10.

The ferrite compound-mixed resin layer 13 shielded on the outer circumference of the shielding layer 12 is formed by an extrusion formation as a core of the core wire bundle 11A shielded by the shielding layer 12. That is, a ferrite compound is evenly and thoroughly mixed in a solution of a synthetic resin, the synthetic resin solution is ejected in a way as shielding on the outer circumference of the shielding layer 12 through a predetermined mold by the extrusion formation, and is elastically hardened. Thus, the ferrite compound-mixed resin layer 13 is formed.

In such a manner, the ferrite compound-mixed resin layer 13 reaches over a full length of the core wire bundle 11A and shields around the axial core of the core wire bundle 11A. By providing the ferrite compound-mixed resin layer 13, permeability is large and frequency characteristic is good in comparison with other magnetic layers, and accordingly, the considerably high EMI noise suppressing effect may be expected.

When the ferrite compound-mixed resin solution is extrusion-formed as mentioned above, since the circumference of the core wire bundle 11A is shielded by the shielding layer 12, the extrusion formation is smoothly performed.

For the core wire bundle 11A, the shielding layer 12 shielding the core wire bundle 11A, and the ferrite compound-mixed resin layer 13 shielding the shielding layer 12 with a film formed on the shielding layer 12, an outer shielding layer 14 called as the sheath layer is provided on an uppermost layer, so that a whole is protected by an outer shielding layer 14.

Thus, with respect to the EMI suppressing cable 10 of the first embodiment, since the ferrite compound-mixed resin layer 13 is formed by the extrusion formation, the ferrite compound-mixed is evenly and thoroughly provided over the full length of the EMI suppressing cable 10. Accordingly, the invention can exhibit the EMI suppressing effect very efficiently over the full length of the cable in comparison with the EMI suppressing cable of the related art locally outside mounted, and a minute mixing amount of the ferrite compound-mixed is sufficient for the expensive ferrite core advantageously also in cost and in restriction of furnishing space and weight without spoiling fine appearances.

To state in more detail, by properly selecting the mixing amount and the layer thickness of the ferrite compound, it is possible to suppress EMI noises at lower cost and more efficiently than the related art.

The EMI suppressing cable 10 is not only used to the cable for connecting a main body of the home computer game machine to the game controller, but also, of course, to other electronic machinery or electric products.

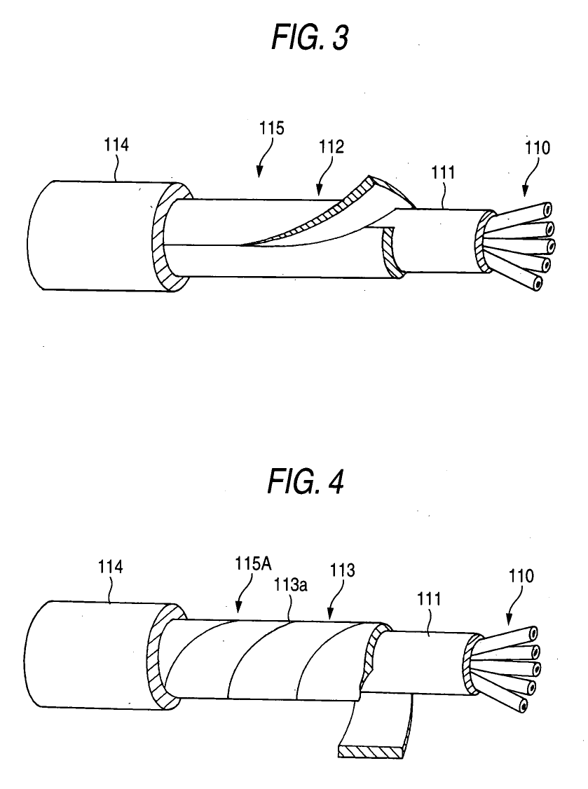

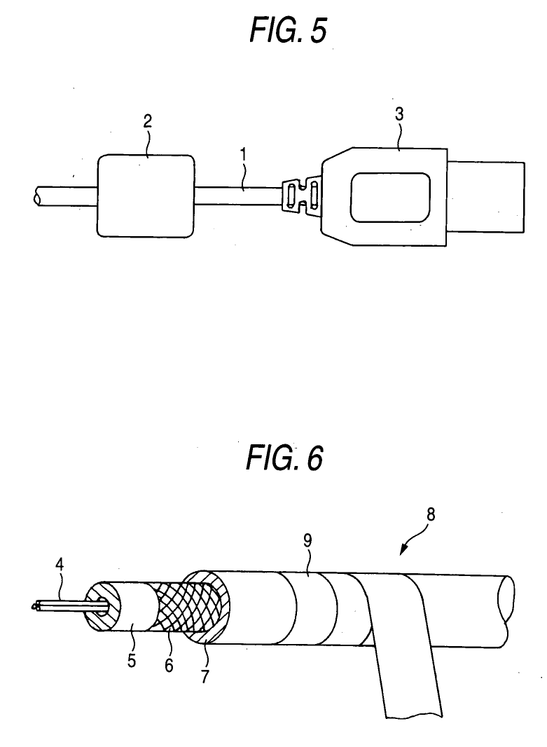

Next, second and third embodiments of the invention will be explained in detail, referring to FIGS. 3 and 4. FIG. 3 shows the EMI suppressing cable according to a second embodiment of the invention, and FIG. 4 shows the EMI suppressing cable according to a third embodiment of the invention. In the drawings, reference numeral 110 designates a core wire bundle having the insulative covering layer, numeral 111 is a shielding layer formed on the outer circumference of the core wire bundle having the insulative covering layer, numerals 112 and 113 are ferrite compound-mixed resin layers of the second and third embodiments formed on the outer circumferences of the shielding layers, and the third embodiment shows the ferrite compound-mixed resin layer wound with a ferrite compound-mixed resin tape 113a on the outer circumference of the shielding layer 111. Numeral 114 is a sheath layer (an outer shield) formed on the outside of the ferrite compound-mixed resin layer 113 wound with the ferrite compound-mixed resin layer 112 or the ferrite compound-mixed resin tape 113a. The above mentioned structures form the EMI suppressing cable 115 corresponding to the second embodiment of the invention, and the EMI suppressing cable 115A corresponding to the third embodiment thereof.

The second embodiment (see FIG. 3) and the third embodiment (see FIG. 4) are concerned with the method of producing the EMI suppressing cable 115 and 115a. The EMI suppressing cable 115 and 115a is produced by steps of forming and covering the shielding layer 111 on the outer circumference of the core wire bundle 110 having the insulative covering layer, forming and covering the ferrite compound-mixed resin layer on the outer circumference of the shielding layer 111, and subsequently forming and covering the sheath layer 114 on the outside of the ferrite compound-mixed resin layer 112.

The shielding layer 111 is made of the flexibility conductive material such as a metal-braided wire layer, a metal tape layer, a mesh metal wire mixed resin layer, or a metal foil for covering thereon.

The ferrite compound-mixed resin layer 112 shown in FIG. 3 is formed by properly adjusting a mixing ratio of ferrite powders in order to compound within the resin. In a result a ferrite compound-mixed resin tape is obtained, and then the outer circumference of the shielding layer 111 is covered with the ferrite compound-mixed resin tape.

As shown in FIG. 4, the ferrite compound-mixed resin tape ll3a formed to be narrow in width is spirally wound on the outer circumference of the shielding layer 111 for forming the ferrite compound-mixed resin layer 112.

To state in more detail, the shielding layer 111 is formed by infiltrating polyester resin or polyvinylchloride resin into the metal-braided wire of flexibility, otherwise the mesh metal wire made of the metal tape or the conductive metal fine wire. the outer circumference of the core wire bundle 110 is directly covered with the shielding layer 111 for protecting the core wire bundle 110 from injuries. Since the shielding layer 111 is formed by infiltrating polyester resin or polyvinylchloride resin into the mesh metal wire, adhesion, strength and endurance of the resin are improved, and the core wire bundle 110 is avoided from injuries, so that reliability and endurance of the EMI suppressing cables 115 and 115A may be expected.

The ferrite compound-mixed resin layer 113 is wound with the ferrite compound-mixed resin layer 112 or the ferrite compound-mixed resin tape 113a, thereby permeability is large and frequency characteristic is good in comparison with other magnetic layers and frequency characteristic is preferable. Accordingly, a considerably high EMI noise suppressing effect may be expected.

In the second embodiment, as shown in FIG. 3, the ferrite compound-mixed resin layer 112 is the ferrite compound-mixed resin tape being comparatively large in width, this ferrite compound-mixed resin tape is covered with the shielding layer 111 for protecting on the outer circumference of the core wire bundle 110, thereby the EMI suppressing cable 115 is produced. In such a way, adopting the wide tape, the ferrite compound-mixed resin layer 112 is formed easily and precisely to be equal thickness, so that a thin layer is available, a proper EMI suppressing function can be exhibited, and as mentioned above, reliability and endurance of the EMI suppressing cable maybe expected.

Furthermore, as shown in FIG. 4, in regard to the ferrite compound-mixed resin layer 113, the ferrite compound-mixed resin tape 113a is formed to be comparatively narrow in width. The ferrite compound-mixed resin tape 113a is spirally wound on the shielding layer 111, whereby the EMI suppressing cable 115A of the third embodiment is produced. At this time, by adjusting the spirally winding pitch, the EMI suppressing function, reliability and endurance are more improved in comparison with related amorphous magnetic substances.

The sheath layer 114 is preferably colored and formed with the resin as the polyester resin or polyvinylchloride resin on the outer circumference of the ferrite compound-mixed resin layer 112 or 113 as the insulative covering layer of an outermost layer, that is, an outer covering in order to distinguish the cables.

The EMI suppressing cable 115 or 115A of the invention is formed in layered structure, and the producing process is simplified to heighten productivity, and contributes to cost-down. In addition, the outside mounted ferrite core or the controlling parts of the related art may be saved. Incorporation in the electronic machinery is made easy. Thus, the invention can reply to needs of miniaturization of the electronic machinery and weight reduction.

By the way, so far as not being beyond the spirit of the invention, various modifications are available, and of course, the invention comes up to the modifications.

What is claimed is:

1. An EMI suppressing cable, comprising:
a core wire bundle, including a plurality of core wires which are respectively covered with insulative covering layers;
a ferrite compound-mixed resin layer, covering the core wire bundle; and
a sheath layer, covering the ferrite compound-mixed resin layer.

2. The EMI suppressing cable as set forth in claim 1, wherein a shielding layer is interposed between the core wire bundle and the ferrite compound-mixed resin layer.

3. The EMI suppressing cable as set forth in claim 1, wherein the ferrite compound-mixed resin layers are formed by an extrusion formation.

4. The EMI suppressing cable as set forth in claim 2, wherein the shielding layer is comprised of a flexibility conductive material having at least one of a metal-braided wire layer, a metal tape layer and a metal foil.

5. The EMI suppressing cable as set forth in claim 2, wherein the ferrite compound-mixed resin layer is a ferrite compound-mixed resin tape in which ferrite powders are evenly compound within resin; and
wherein, the ferrite compound-mixed resin tape covers the shielding layer.

6. The EMI suppressing cable as set forth in claim 5, wherein the ferrite compound-mixed resin tape is spirally wound on the shielding layer around an axis direction of the core wire bundle.

7. The EMI suppressing cable as set forth in claim 5, wherein the ferrite compound-mixed resin tape is wound on the shielding layer in a direction perpendicular to an axis direction of the core wire bundle.

8. A method of producing an EMI suppressing cable, comprising the steps of:
providing a core wire bundle which includes a plurality of core wires respectively covered with insulative covering layers;
covering the core wire bundle with a shielding layer;
covering the shielding layer with a ferrite compound-mixed resin layer; and
covering the ferrite compound-mixed resin layer with a sheath layer.

9. The method as set forth in claim 8, wherein the ferrite compound-mixed resin layers are formed by an extrusion formation.

10. The method as set forth in claim 8, wherein the shielding layer is comprised of a flexibility conductive material having at least one of a metal-braided wire layer, a metal tape layer and a metal foil.

11. The method as set forth in claim 8, wherein the ferrite compound-mixed resin layer is a ferrite compound-mixed resin tape, and the method further comprising the step of covering the shielding layer with the ferrite compound-mixed resin tape formed by adjusting a mixing ratio of ferrite powders in the resin so that the ferrite powders is evenly compound in the resin.

12. The method as set forth in claim 11, wherein the ferrite compound-mixed resin tape is spirally wound on the shielding layer around an axis direction of the core wire bundle while adjusting a winding pitch.

13. The method as set forth in claim 11, wherein the ferrite compound-mixed resin tape is wound on the shielding layer in a direction perpendicular to an axis direction of the core wire bundle.
